(19) United States
(12) Patent Application Publication
(10) Pub. No.: US 2011/0158863 A1
(43) Pub. Date: Jun. 30, 2011

(54) HOLDING MATERIAL FOR CATALYTIC CONVERTER

(75) Inventors: Nobuya TOMOSUE, Shizuoka (JP); Kazutoshi Isomura, Shizuoka (JP); Junya Satoh, Shizuoka (JP)

(73) Assignee: NICHIAS CORPORATION, Tokyo (JP)

(21) Appl. No.: 12/979,540

(22) Filed: Dec. 28, 2010

(30) Foreign Application Priority Data
Dec. 28, 2009 (JP) P 2009-298101

(51) Int. Cl. B01J 8/06

(52) U.S. Cl. 422/312

(57) ABSTRACT

The present invention relates to a holding material for a catalytic converter containing a catalyst carrier, a metal casing for receiving the catalyst carrier, and the holding material wound around the catalyst carrier and interposed in a gap between the catalyst carrier and the metal casing, in which the holding material contains an organic substrate and a protective film having a plurality of pores, and the protective film is joined to a metal casing-side surface of the substrate.

### FIELD OF THE INVENTION

The present invention relates to a holding material for a catalytic converter (hereinafter simply referred to as a “holding material”), in order for holding a catalyst carrier in a metal casing. The catalyst carrier is incorporated in a catalytic converter for removing particulates, carbon monoxide, hydrocarbons, nitrogen oxides and the like contained in exhaust gas discharged from an internal combustion engine such as a gasoline engine or a diesel engine.

### BACKGROUND OF THE INVENTION

As conventionally known, a vehicle such as an automobile is equipped with a catalytic converter for exhaust gas-purifying in order to remove harmful components such as carbon monoxide, hydrocarbons and nitrogen oxides contained in exhaust gas from its engine. FIG. 7 is a cross-sectional view schematically showing one example of a catalytic converter. In the catalytic converter 10, an introduction pipe 16 through which exhaust gas discharged from an internal combustion engine is introduced is connected to one end of a metal casing 11, and a discharge pipe 17 through which the exhaust gas which has passed through a catalyst carrier 12 is discharged outside is attached on the other end thereof. The catalyst carrier 12 is provided inside the metal casing 11 with the intervention of a holding material 13.

The catalyst carrier 12 generally has a structure that a noble metal and the like are supported on a cylindrical honeycomb compact comprising, for example, cordierite. For this reason, the holding material 13 is required to have a function of safely holding the catalyst carrier 12 so as not to cause that the catalyst carrier 12 collides the metal casing 11 by vibration and the like during running of the automobile and breaks, and a function of sealing such that unpurified exhaust gas does not leak from a gap between the catalyst carrier 12 and the metal casing 11. In view of the requirement, at present a holding material obtained by molding inorganic fibers such as alumina fibers, mullite fibers or other ceramic fibers in a mat shape having a given thickness using an organic binder is a mainstream holding material. The shape of the mat-like holding material is a plane shape as shown in FIG. 8A, in which a convex portion 42 is formed at one end of a flat plate-like main body portion 41, and a concave portion 43 having a shape capable of fitting to the convex portion 42 is formed at the other end thereof. As shown in FIG. 8B, the main body portion 41 is wound around the outer periphery of the catalyst carrier 12, and the convex portion 42 and the concave portion 43 are engaged. Thus, the main body portion 41 is provided on the catalyst carrier 12 in a wound form.

The organic binder used includes, generally, rubbers, water-soluble organic polymer compounds, thermoplastic resins, thermosetting resins and the like. When the holding material 13 has too large thickness, work for winding the holding material 13 around the catalyst carrier 12 and work for inserting the holding material 13 into the metal casing 11 become difficult to perform. Therefore, the holding material 13 is required to decrease its thickness to a certain extent. For this reason, the general holding material 13 uses the organic binder in an amount of from 5% to 8% by mass, and in the largest case, about 10% by mass, based on the total amount of the holding material.

However, recently the catalyst carrier 12 is heated to near 1,000° C. in order to increase purification efficiency of exhaust gas. In such a case, the organic binder described above easily decomposes and burns out, thereby generating CO₂, CO or various organic gases. In particular, those gases are generated in large amounts at the initial stage of actuation of a catalytic converter. The emission control becomes the more severe, and there is a possibility that the amount of various organic gases discharged exceeds the defined value owing to CO₂ and the like derived from the organic binder. Furthermore, electronic control is proceeding recently. However, where CO₂ unrelated to the intended exhaust gas is present, the CO₂ causes malfunction of sensors of exhaust system and adversely affects electronic control of the engine. In order to prevent those disadvantages, the manufacturers are performing the work that the catalytic converter is subjected to burning treatment to burn out the organic binder before shipment thereof.

It is considered to reduce an amount of the organic binder used, but there is the problem that binding force of inorganic fibers is decreased with reduced the amount of the organic binder used, resulting in increase in the thickness of the holding material 13, and winding properties of the holding material 13 are deteriorated. Furthermore, due to decrease in the amount of the organic binder used, there are possible problems of decrease in strength and increase in friction coefficient of the surface at the casing side of the holding material 13.

Further, recently, in producing a catalytic converter, the mainstream technique is that the catalyst carrier 12 around which the holding material 13 has been wound is inserted under pressure in the cylindrical metal casing 11, and a protective film 50 such as a film, a tape, a non-woven fabric or a resin coating layer is formed on the surface at the casing side of the holding material 13, thereby attempting to reduce frictional resistance at the time of insertion under pressure and reinforce the surface at the casing side of the holding material 13 (see Patent Documents 1 and 2).
Patent Document 1: JP-A-2001-32710
Patent Document 2: JP-A-8-61054 (1996)

### SUMMARY OF THE INVENTION

Since the protective film itself has low frictional resistance, such a holding material 13 having the protective film 50 formed thereon has excellent canning property and therefore, it is expected to increase production efficiency. However, in the winding work winding the holding material 13 around the catalyst carrier 12, length of the outer periphery having the protective film formed thereon of the holding material 13 becomes large as compared with length of the inner periphery contacting the catalyst carrier. In other words, a tension is generated in the outer periphery. As a result, there is a concern that the protective film 50 breaks or a part thereof separates from the holding material 13.

The present invention has been made in view of the above circumstances, and has an object to provide a holding material having a protective film formed thereon, wherein the protective film is perforated to impart (control) stretchability to the protective film, thereby improving winding workability to the catalyst carrier while maintaining the inherent reinforcing effect of the protective film and the reduction effect of frictional resistance at the time of insertion under pressure. In this specification, perforated hole present in the protective film is referred to as “pore”.

### ADVANTAGE OF THE INVENTION

The present invention relates to the following holding materials for a catalytic converter.

(1) A holding material for a catalytic converter comprising a catalyst carrier, a metal casing for receiving the catalyst carrier, and the holding material wound around the catalyst carrier and interposed in a gap between the catalyst carrier and the metal casing,

wherein the holding material comprises an inorganic substrate and a protective film having a plurality of pores, and the protective film is joined to a metal casing-side surface of the substrate.

(2) The holding material for a catalytic converter according to the above (1), wherein the protective film has a pore ratio of from 10% to 45%.
(3) The holding material for a catalytic converter according to the above (1) or (2), wherein the pore has a circular shape or an ellipsoidal shape.
(4) The holding material for a catalytic converter according to any one of the above (1) to (3), wherein the pore has a length of the minimum diameter of 5 mm or more.
(5) The holding material for a catalytic converter according to any one of the above (1) to (4), wherein the protective film has a plurality of pores, and a distance between the adjacent pores is 3 mm or more.
(6) The holding material for a catalytic converter according to any one of the above (1) to (5), wherein the protective film having the pore formed thereon has a basis weight of 20 g/m² or less.
(7) The holding material for a catalytic converter according to any one of the above (1) to (6), which contains organic components in an amount of 3% by mass or less based on the total amount of the holding material.

Because the holding material of the present invention has a protective film having a plurality of pores formed thereon, the holding material has small difference in area between the state of winding around a catalyst carrier and the state of heating and burning out the protective film before shipment in comparison with the case of a protective film having no pores, thereby flexibility of the whole of the protective film is enhanced, and winding workability to the catalyst carrier is also enhanced. As a result, winding workability to the catalyst carrier can be improved while maintaining the inherent reinforcing effect of the protective film and the reduction effect of frictional resistance at the time of insertion under pressure. Furthermore, the amount of organic components generated when the protective film burned out is reduced, burning-out work before shipment of a catalytic converter can be performed in a shorter period of time, and discharge facilities can make a smaller scale.

### BRIEF DESCRIPTION OF THE DRAWINGS

FIG. 1A is a plane view showing the holding material for a catalytic converter of the present invention, and FIG. 1B is a perspective view showing the state that the holding material of the present invention has been wound around a catalyst carrier.

FIG. 2 is a plane view showing another example of the pore pattern.

FIG. 3 is a plane view showing another example of the pore pattern.

FIG. 4 is a plane view showing another example of the pore pattern.

FIG. 5 is a plane view showing another example of the pore pattern.

FIGS. 6A and 6B are a top view showing the holding materials used in the Examples.

FIG. 7 is a cross-sectional view showing one example of the catalytic converter.

FIG. 8A is a plane view of the conventional holding material for a catalytic converter, and FIG. 8B is a perspective view showing the state that the conventional holding material has been wound around a catalyst carrier.

### DETAILED DESCRIPTION OF THE INVENTION

The present invention is described in detail below by reference to the drawings. However, the scope of the invention should not be construed as being limited to the embodiments.

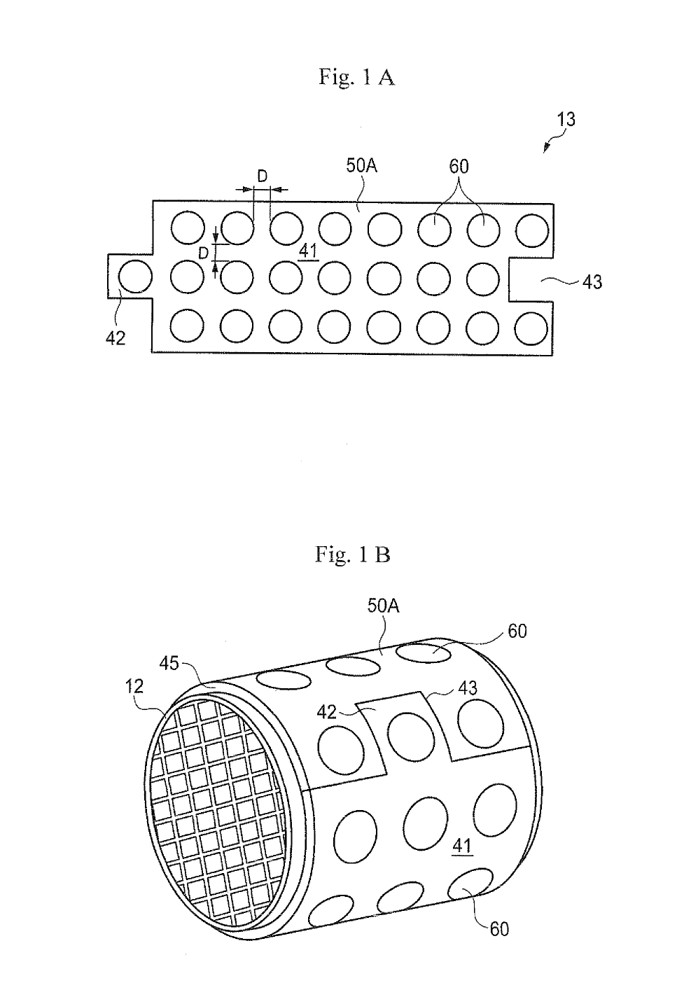

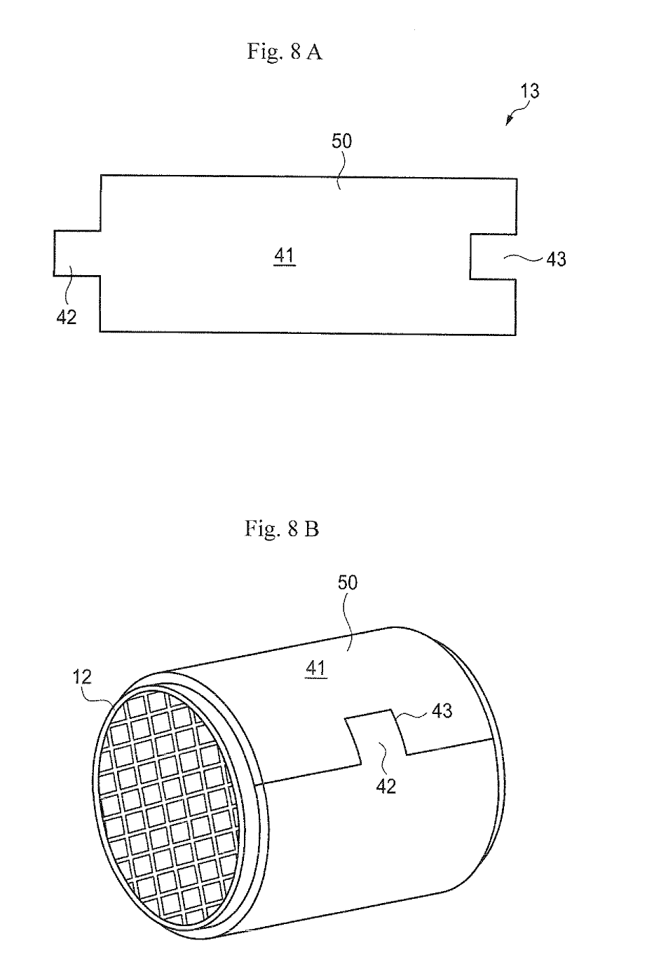

FIGS. 1A and 1B show one example of a holding material 13 of the present invention. FIG. 1A is a plane view corresponding to FIG. 8A, and FIG. 1B is a perspective view corresponding to FIG. 8B. As shown in FIGS. 1A and 1B, a protective film 50A is joined to the metal casing-side surface of an inorganic fiber substrate 45, and many circular pores 60 are formed over the entire surface of the protective film 50A.

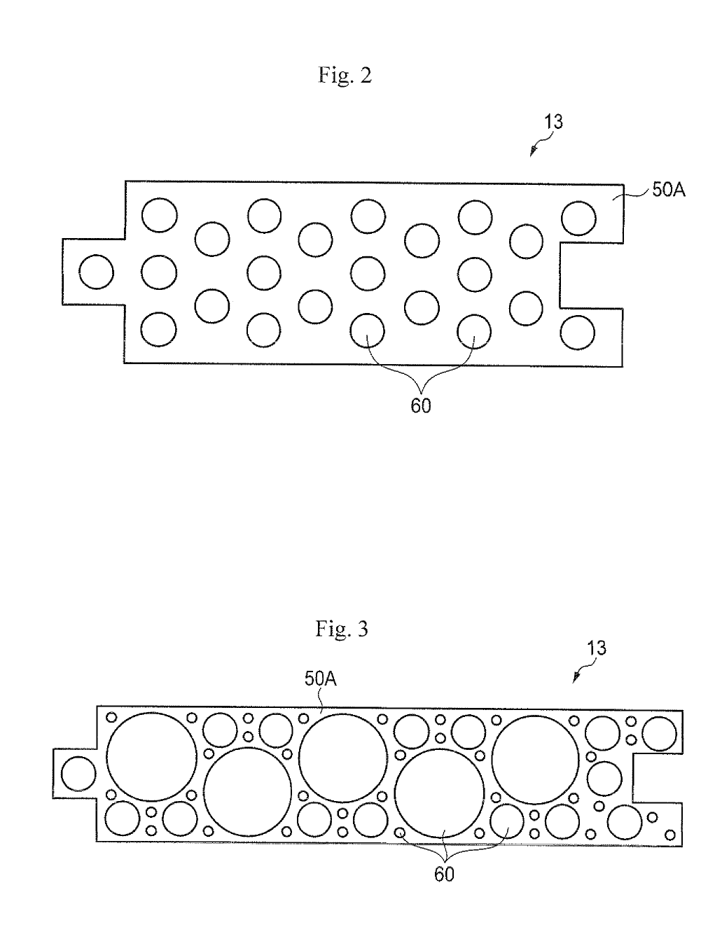

Formation pattern of the pores 60 is that the pores are formed at equal interval as shown in FIGS. 1A and 1B, and other than this, the pores may be formed in a houndstooth check shape as shown in FIG. 2. Furthermore, although not shown, the pores may be formed at random. Additionally, circles having difference sizes may be combined as shown in FIG. 3.

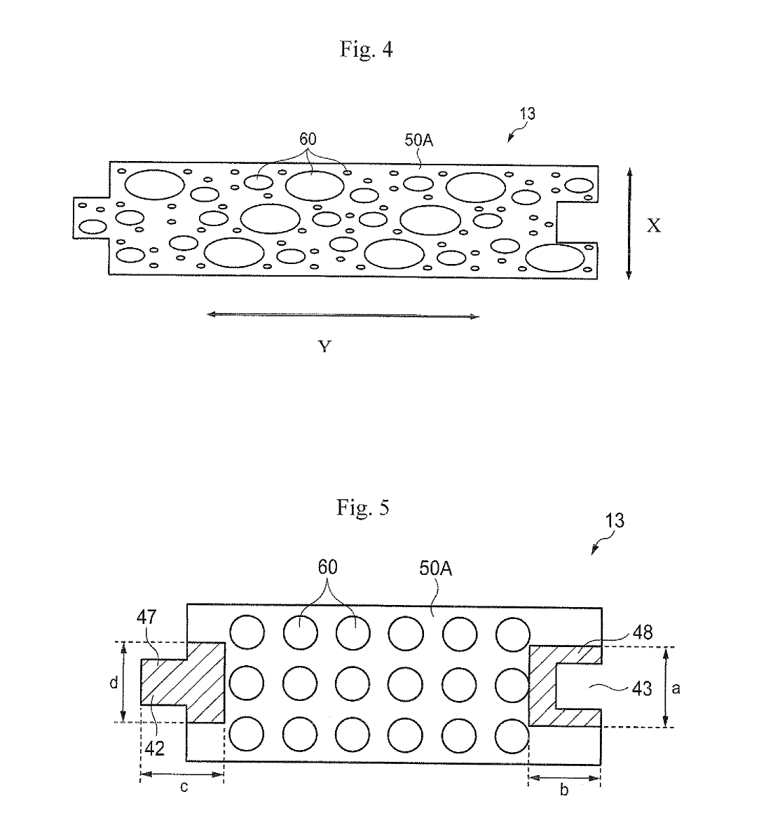

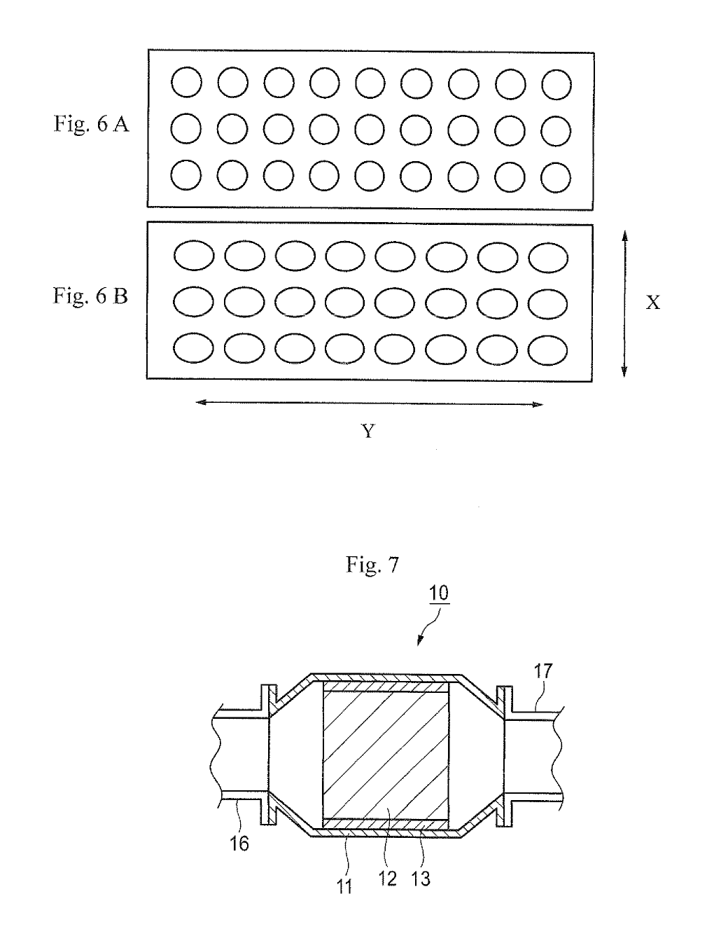

The pores 60 may be an ellipsoidal shape as shown in FIG. 4, other than a circle. A long axis of the ellipse may be formed along a longitudinal direction (Y direction in FIG. 4) of the holding material 13 as shown in FIG. 4, may be formed so as to be perpendicular (X direction in FIG. 4) to the longitudinal direction, and may be formed along an oblique direction to the longitudinal direction. The holding material 13 is that its width direction faces a direction of insertion under pressure at the time of insertion under pressure. Therefore, when the pores 60 are formed such that the long axis of the ellipse coincides with the width direction of the holding material 13, this formation facilitates insertion under pressure of the holding material. On the other hand, when the pores 60 are formed such that the long axis of the ellipse coincides with the longitudinal direction of the holding material 13, this formation facilitates curvature of the holding material in winding the holding material around the catalyst carrier 12. Furthermore, ellipses having different sizes may be combined as shown in FIG. 4. There is the advantage that the ellipsoidal pore has tensile strength superior to the circular pore as shown in Test 1.

Here, the term “ellipse” is not limited to the ellipse in a precise mathematical sense. The term is a concept containing a shape approximated ellipse achieving the effects of the present invention.

The pores 60 have the length of the minimum diameter of preferably 5 mm or more, and more preferably 10 mm or more. The length of the minimum diameter is preferably 15 mm or less. Here, the term “minimum diameter” means the smallest diameter among the diameters passing through the approximated center of the pore. That is, the diameter in the case of the circle as shown in FIGS. 1 to 3 and the short axis in the case of the ellipse as shown in FIG. 4. In the case that the pores 60 having different sizes are present in a mixed state as shown in FIGS. 3 and 4, the diameter or the short axis of the smallest pore is preferably 5 mm or more. The circumference of the pores 60 becomes resistance in conducting insertion under pressure. Therefore, although more pores 60 must be formed with decreasing the size of the pores, it causes increase of frictional resistance at the time of insertion under pressure. On the other hand, where the size of the pores exceeds 30 mm, the substrate 45 is exposed in large area, it may cause increase of frictional resistance at the time of insertion under pressure.

In the case where a plurality of pores are present, the distance D between the adjacent pores 60 is preferably 3 mm or more, and more preferably more than 5 mm. The distance D is preferably 15 mm or less. A portion of the protective film 50A between the pores decreases its width with narrowing the distance between the adjacent pores 60. Therefore, when the distance between the adjacent pores 60 is too narrow, the protective film 50A is liable to break at the time of insertion under pressure. On the other hand, a portion of the protective film 50A between the pores 60 increases its width with widening the distance between the adjacent pores 60. Therefore, when the distance between the adjacent pores 60 is too wide, the protective film 50A is suppressed from breakage at the time of insertion under pressure, but the effect derived from providing the pores 60 is decreased.

It is preferred that the pores 60 are not formed on a peripheral region 47 of a convex portion 42 and on a peripheral region 48 of a concave portion 43, of a main body portion 41 of the holding material 13, as shown in FIG. 5. As shown in FIG. 1B, the convex portion 42 and the concave portion 43 are portions that are engaged when the holding material 13 is wound around the catalyst carrier 12. When difference in level is present in the engaged edge, the holding material may catch in the inside of a metal casing at the time of insertion under pressure. Even in the case that difference in level is present in the engaged edge, frictional resistance is decreased by virtue of the protective film 50A, and the holding material is easily inserted under pressure in the metal casing. However, when the pores 60 are present, the substrate 45 is exposed, thereby increasing frictional resistance correspondingly. From the view point, frictional resistance can be reduced as possible by that the pores 60 are not formed on only the peripheral portions 47 and 48 of the convex portion 42 and the concave portion 43. As a result, the frictional resistance at the time of insertion under pressure can be decreased with widening the peripheral portions 47 and 48, but the effect derived from providing the pores 60 is decreased. Therefore, the area of the peripheral portions 47 and 48 is preferably that the size “a” shown in FIG. 5 is from 50% to 100% of the overall width of the holding material, the size “b” shown in FIG. 5 is from 5% to 9% of the overall length of the holding material, the size “c” shown in FIG. 5 is from 5% to 9% of the overall length of the holding material, and the size “d” shown in FIG. 5 is from 50% to 100% of the overall width of the holding material.

In formation styles of the pores 60, a pore ratio of the pores 60, that is, the proportion of the total area of the pores 60 to the total area of the protective film 50A, is preferably from 10% to 45%, and more preferably from 20% to 35%, in any cases. Decrease in the inherent effect of the protective film is reduced with decreasing the pore ratio, but the effect derived from providing the pores 60 is decreased. On the other hand, decrease in the inherent effect of the protective film is increased with increasing the pore ratio. Furthermore, in the case where the pore ratio is large, the substrate 45 is exposed larger, and the frictional resistance is increased correspondingly, resulting in deterioration of calming property. Therefore, the above pore ratio range is achieved by controlling a size of the pores 60, a distance between the pores, a combination of pores having different sizes, formation pattern and the like.

As a material of the protective film 50A, the conventional materials can be used, and examples thereof include films and non-woven fabrics, comprising polyethylene, ethylene-vinyl acetate copolymer, polypropylene, polyvinyl chloride, polyvinyl acetate, polyvinyl alcohol, polyamide, polystyrene, polycarbonate, polyethylene terephthalate, polybutylene terephthalate or the like. In the present invention, organic non-woven fabrics such as polyethylene resin non-woven fabric, which can be available at low cost, has strength and is easily subjected to perforation processing, can preferably be used.

The thickness of the protective film 50A is not particularly limited. However, in the case where the protective film 50A is too thin, film strength is decreased, and such a protective film is liable to break after winding around the catalyst carrier 12 or at the time of insertion under pressure. On the other hand, in the case where the protective film 50A is too thick, such a protective film is difficult to stretch, and is difficult to wind around the outer periphery of the catalyst carrier 12. Furthermore, in the case where the protective film 50A is too thick, an amount of organic components is increased, and it becomes difficult to suppress the amount of the organic components to 3% by mass or less based on the total amount of the protective film 50A and a substrate 45 described hereinafter. The film strength is preferably 0.5 N/30 mm or more, and more preferably 2 N/30 mm or more, in terms of tensile strength. The tensile strength is measured according to JIS P 8113 (2007). To satisfy such a tensile strength and suppress the amount of organic components, the thickness of the protective film 50A is preferably 20 g/m² or less, more preferably from 2 to 10 g/m², and further preferably from 2 to 5 g/m², in terms of basis weight after formation of the pore.

In the case that the protective film 50A comprises an organic non-woven fabric, fibers may be present randomly on the surface thereon. However, by orienting the fibers in a longitudinal direction of the holding material 13, the protective film 50A easily stretches in a circumferential direction in winding the protective film around the outer periphery of the catalyst carrier 12, thereby improving winding properties. When the fibers are oriented in a width direction of the holding material 13, film strength in a direction of insertion under pressure is increased.

To join the protective film 50A to the substrate 45, a method of adhering a protective film (such as a film or a non-woven fabric), having the pore 60 formed thereon to the substrate 45 by using an adhesive or by hot press can be used. However, in the method of using an adhesive, the amount of the organic components is increased. Further, the adhesive protrudes outside the peripheral edge of the pore 60, and furthermore protrudes from voids of fibers in the case of the non-woven fabric, and this possibly leads to poor appearance. For this reason, hot press is preferably used.

The substrate 45 is not limited. For example, an inorganic substrate such as mat materials such as a compacted mat obtained by subjecting inorganic fibers and a small amount of an organic binder to wet molding and then drying the resulting molding in a compacted state; a mat comprising a blanket obtained by bundling inorganic fibers and subjecting the bundle to needle processing; and an expanded mat obtained by subjecting inorganic fibers and an expansion agent such as vermiculite to wet molding can be used.

The overall shape of the holding material 13 is not limited. For example, as shown in FIG. 1A, the holding material can have a shape that the convex portion 42 is formed at one end of the flat plate-like main body portion 41 and the concave portion 43 having a shape capable of fitting to the convex portion 42 is formed on other end thereof. The shape of the convex portion 42 and the concave portion 43 is not limited to a rectangle shown, in the drawings, and can be a triangle, a semicircle or the like. Furthermore, the number of the convex portion 42 and the concave portion 43 is not limited to one, and can be two or more, respectively.

As the inorganic fibers, various inorganic fibers conventionally used as a holding material can be used. For example, alumina fibers, mullite fibers, or other ceramic fibers can appropriately be used. More specifically, the alumina fibers are preferably alumina fibers having Al₂O₃ content of 90% by weight or more (the remainder is SiO₂ component) and low crystallinity in terms of X-ray crystallography, and further having an average fiber diameter of from 3 μm to 10 μm and a wet volume of 300 cc/5 g or more. The mullite fibers are preferably mullite fibers having a mullite composition in which, for example, Al₂O₃ component/SiO₂ component weight ratio is from about 70/30 to 83/17, and low crystallinity in terms of X-ray crystallography, and further having an average fiber diameter of from 3 μm to 10 μm and a wet volume of about 300 cc/5 g. The other ceramic fibers include silica alumina fibers. The fibers conventionally used in a holding material can be used in those inorganic fibers. The inorganic fibers may contain glass fibers, silica fibers, rock wool and bio-soluble inorganic fibers.

The wet volume is calculated by the following method.

1) 5 g of a dry fiber material is weighed by a balance having a precision of two places or more of decimals.
2) The weighed fiber material is placed in 500 ml glass beaker.
3) About 400 cc of distilled water having a temperature of from 20 to 25° C. is placed in the glass beaker of 2) above, and the resulting mixture is stirred with a stirrer in a careful manner such that the fiber material does not cut, thereby dispersing the fiber material in the distilled water. The dispersion may be conducted by using an ultrasonic washing machine.
4) The contents in the glass beaker of 3) above are transferred to a 1,000 ml measuring cylinder, and distilled water is added to the measuring cylinder up to 1,000 cc in the scale.
5) The mouth of the measuring cylinder of 4) above is clogged with hand or the like, and the measuring cylinder is turned upside down while watching out that water does not leak, followed by stirring. This operation is repeated 10 times in all.
6) After stopping the stirring, the measuring cylinder is allowed to stand at room temperature, and a volume of fibers precipitated after 30 minutes is visually measured.
7) The above operation is conducted using three samples, and its average value is used as a measurement value.

As the organic binder used in the present invention, it can be used the conventional organic binders, and can be used rubbers, water-soluble organic polymer compounds, thermoplastic resins, thermosetting resins, and the like. Specifically, examples of the rubbers include a copolymer of n-butyl acrylate and acrylonitrile, a copolymer of ethyl acrylate and acrylonitrile, a copolymer of butadiene and acrylonitrile, and butadiene rubber. Examples of the water-soluble organic polymer compounds include carboxymethyl cellulose and polyvinyl alcohol. Examples of the thermoplastic resins include a homopolymer and a copolymer of acrylic acid, acrylic acid ester, acrylamide, acrylonitrile, methacrylic acid and methacrylic acid ester; an acrylonitrile-styrene copolymer and an acrylonitrile-butadiene-styrene copolymer. Examples of the thermosetting resins include bisphenol type epoxy resin and novolak type epoxy resin.

The substrate 45 can contain a small amount of an organic fiber such as pulp as an organic binder. Binding force is increased as the organic fiber is finer and longer. Highly fibrilized cellulose, cellulose nanofiber and the like are preferably used. Specifically, the organic fiber has preferably a fiber diameter of from 0.01 μm to 50 μm and a fiber length of from 1 μm to 5,000 μm, and more preferably a fiber diameter of from 0.02 μm to 1 μm and a fiber length of from 10 μm to 1,000 μm.

Such an organic binder can be used by combining two kinds or more thereof. The amount of the organic binder used is not limited so long as it is an amount capable of binding the inorganic fibers, and is generally from 0.1 to 10 parts by mass based on 100 parts by mass of the inorganic fibers. In the case where the amount of the organic binder is less than 0.1 parts by mass, binding force is insufficient, and in the case where the amount exceeds 10 parts by mass, there is a possibility that when the organic binder burns out, the amount of the exhaust gas generated exceeds the value of emission control. The amount of the organic binder used is preferably from 0.2 to 6 parts by mass, and more preferably from 0.2 to 3 parts by mass.

The organic binder may be used together with an inorganic binder. The combined use of the organic binder and the inorganic binder can well bundle inorganic fibers even in the case that the amount of the organic binder used is decreased in order to avoid the above-described disadvantages due to volatilization of the organic component at the time of use, and can provide a holding material for a catalyst converter that can maintain the thickness equivalent to the conventional thickness. As the inorganic binder, the conventional inorganic binders can be used, and examples thereof include clay type inorganic binders such as glass frit, colloidal silica, alumina sol, sodium silicate, titanic sol, lithium silicate, liquid glass and bentonite. Those inorganic binders can be used in combination of two kinds or more thereof. The amount of the inorganic binder used is not limited so long as it is an amount capable of bundling the inorganic fibers, and is generally from 0.1 to 10 parts by mass based on 100 parts by mass of the inorganic fibers. In the case where the amount of the inorganic binder used is less than 0.1 parts by mass, binding force is not sufficient. And in the case where the amount exceeds 10 parts by mass, the amount of the inorganic fibers is relatively decreased as a result, it is possible that holding performance and sealing performance necessary as a holding material are not obtained. The amount of the inorganic binder used is preferably from 0.2 to 6 parts by mass, and more preferably from 0.2 to less than 4 parts by mass.

The amount of the organic components based on the whole of the holding material, that is, the sum of the amount of the organic components of the substrate 45 and the protective film 50A in the case of shown in FIG. 1A, is preferable as the amount is decreased. Specifically, the amount of the organic components is preferably 3% by mass or less, more preferably 2% by mass or less, further preferably 1.5% by mass or less, particularly preferable 1.0% by mass or less, and especially preferably 0.5% by mass or less based on the total amount of the holding material. Therefore, it is preferred in the substrate 45 that a slight amount of the organic components is used such that the organic binder and the organic fibers can maintain a compacted state. The organic components based on the whole of the holding material is obtained as follows. First, the weight of the holding material (W₁) is measured. The holding material is heated for 30 min in an electric furnace heated to 700° C., and the weight of the holding material after heating (W₂) is measured. The organic components (%) in the holding material is determined by substituting the respective values into the following expression.

The organic components (%)={(W₁−W₂)/W₁}×100

### Examples

The present invention is described in more specifically below by reference to the following Examples and Comparative Examples, but the invention is not construed as being limited thereto.

### Test 1

Polyethylene non-woven fabrics each having a basis weight of 5 g/m², a length of 120 mm and a width of 70 mm were subjected to perforation processing to form circular pores or ellipsoidal pores thereon as shown in Table 1, and the non-woven fabrics thus processed were used as test pieces. The number of pores in a longitudinal direction was three, and the number of the pores in a width direction was one. In table 1, the distance of from the end to the pore is a size “b” in FIG. 5. The test pieces were mounted on a tensile tester according to JIS P 8113 (2007), and the maximum point load (load reaching breakage) and the amount of elongation of each of the non-woven fabrics until reaching a tensile load of 7N were measured at a tensile rate of 10 mm/min. The results obtained are shown in Table 1. The results of the tensile test are shown in Table 1 by relative values as that the measurement value of the polyethylene non-woven fabric (Test No. 6) on which pores are not formed is 100. It is seen from the results shown in Table 1 that the ellipsoidal pores show high tensile strength as compared with that of the circular pores, and therefore have high effect of suppressing breakage of a protective film at the time of insertion under pressure of a holding material. It is further seen from Table 1 that the non-woven fabrics having pores formed thereon have good stretchability as compared with the non-woven fabric on which the pores are not formed.

TABLE 1

| Test No. | | 1 | 2 | 3 | 4 | 5 | 6 |
|---|---|---|---|---|---|---|---|
| Protective film | | Non-woven | Non-woven | Non-woven | Non-woven | Non-woven | Non-woven |
| | | fabric | fabric | fabric | fabric | fabric | fabric |
| Pore | Shape | Circle | Circle | Ellipse | Ellipse | Ellipse | None |
| | Pore diameter (mm) | 10 | 13 | 10 x 13 | 10 x 13 | 10 x 13 | — |
| | Arrangement of ellipse | — | — | Tensile | Tensile | Tensile | — |
| | (Arrow is tensile direction) | | | direction | direction and | direction and | |
| | | | | coincides with | long axis | long axis | |
| | | | | long axis. | perpendicularly | obliquely | |
| | | | | | cross. | cross. | |
| | | | | 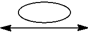 | 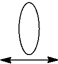 | 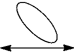 | |
| | Distance of from end to pore (mm) | 30 | 28 | 30 | 29 | 29 | — |
| | Pore area (mm²) | 79 | 133 | 99 | 99 | 99 | — |
| Tensile | Maximum point load (%) | 62 | 56 | 72 | 64 | 62 | 100 |
| test | Elongation (%) | 128 | 142 | 160 | 144 | 126 | 100 |

Note)
Tensile test results are relative values when maximum point load and elongation of Test No. 6 are 100.

### Test 2

A polyethylene film or a polyethylene non-woven fabric each having a length in a longitudinal direction of 530 mm and a length in a width direction of 144 mm was provided, and as shown in Table 2 was subjected to perforation processing to form circular or ellipsoidal pores thereon, thereby obtaining a protective film. The pores in each protective film had the same size, and were formed in three rows in a width direction as shown in FIG. 5, but the number of the pores in a longitudinal direction was changed. The ellipsoidal pores were formed such that the long axis has a direction along a longitudinal direction.

The protective film obtained above each was jointed to one side of an alumina fiber substrate having a length in a longitudinal direction of 530 mm, a length in a width direction of 144 min and a basis weight of 1,200 g/m². Thus, a holding material was obtained. The joining was performed by applying an adhesive with a spray in Example 15 and by using hot press in the other Examples.

In table 2, the judging criteria of winding properties are as follows.

Excellent: It can be wound around a carrier having 70 mm diameter, and has excellent winding properties.

Good: It can be wound around a carrier having 70 to 80 mm diameter, and has good winding properties (less breakable).

Fair: It is equal to an existing protective film (Comparative Example 1).

TABLE 2

| | | Example 1 | Example 2 | Example 3 | Example 4 | Example 5 | Example 6 | Example 7 | Example 8 |
|---|---|---|---|---|---|---|---|---|---|
| Protective film | | Non-woven | Non-woven | Non-woven | Non-woven | Non-woven | Non-woven | Non-woven | Non-woven |
| | | fabric | fabric | fabric | fabric | fabric | fabric | fabric | fabric |
| Pore | Shape | Circle | Circle | Circle | Circle | Circle | Circle | Circle | Circle |
| | Pore diameter | 13 | 13 | 13 | 13 | 10 | 10 | 10 | 10 |
| | (mm) | | | | | | | | |
| | Pore interval | 27 | 12 | 7 | 5 | 17 | 10 | 6 | 4 |
| | (mm) | | | | | | | | |
| | Pitch (mm) | 40 | 25 | 20 | 18 | 27 | 20 | 16 | 14 |
| | Number of pore | 65 | 126 | 189 | 232 | 100 | 189 | 297 | 380 |
| | Pore ratio (%) | 11 | 22 | 33 | 40 | 10 | 19 | 31 | 39 |
| | Basis weight | 4.4 | 3.9 | 3.4 | 3.0 | 4.5 | 4.0 | 3.5 | 3.0 |
| | of non-woven | | | | | | | | |
| | fabric (g/m²) | | | | | | | | |
| | Organic compo- | 0.37 | 0.33 | 0.28 | 0.25 | 0.37 | 0.34 | 0.29 | 0.25 |
| | nents in holding | | | | | | | | |
| | material (%) | | | | | | | | |
| Evaluation | Winding properties | Fair | Good | Good | Fair | Fair | Good | Good | Fair |
| | Possible minimum | 100 | 80 | 70 | 120 | 100 | 80 | 70 | 120 |
| | pipe diameter of | | | | | | | | |
| | winding (mm) | | | | | | | | |

| | | | | | | | | | Comparative |
|---|---|---|---|---|---|---|---|---|---|
| | | Example 9 | Example 10 | Example 11 | Example 12 | Example 13 | Example 14 | Example 15 | Example 1 |
| Protective film | | Non-woven | Non-woven | Non-woven | Non-woven | Non-woven | Non-woven | Film | Non-woven |
| | | fabric | fabric | fabric | fabric | fabric | fabric | | fabric |
| Pore | Shape | Ellipse | Ellipse | Circle | Circle | Circle | Circle | Circle | — |
| | Pore diameter | 10 × 13 | 10 × 15 | 6 | 10 | 16 | 20 | 13 | — |
| | (mm) | | | | | | | | |
| | Pore interval | 10 × 7 | 10 × 5 | 7 | 7 | 7 | 7 | 7 | — |
| | (mm) | | | | | | | | |
| | Pitch (mm) | 20 | 20 | 13 | 17 | 23 | 27 | 20 | — |
| | Number of pore | 156 | 234 | 451 | 248 | 138 | 100 | 189 | — |
| | Pore ratio (%) | 20 | 31 | 17 | 26 | 36 | 41 | 33 | 0 |
| | Basis weight | 4.0 | 3.5 | 4.2 | 3.7 | 3.2 | 2.9 | 3.4 | 5.0 |
| | of non-woven | | | | | | | | |
| | fabric (g/m²) | | | | | | | | |
| | Organic compo- | 0.33 | 0.29 | 0.35 | 0.31 | 0.27 | 0.25 | 0.28 | 0.42 |
| | nents in holding | | | | | | | | |
| | material (%) | | | | | | | | |
| Evaluation | Winding properties | Excellent | Excellent | Fair | Good | Good | Fair | Good | Fair |
| | Possible minimum | 70 | 70 | 100 | 80 | 80 | 110 | 70 | 110 |
| | pipe diameter of | | | | | | | | |
| | winding (mm) | | | | | | | | |

Note)
Only Example 15 joined the film to the substrate by applying an adhesive with a spray.

While the present invention has been described in detail and with reference to specific embodiments thereof, it will apparent to one skilled in the art that various changes and modifications can be made therein without departing from the spirit and scope thereof.

The present application is based on Japanese Patent Application No. 2009-298101 filed on Dec. 28, 2009, and the entire contents thereof are incorporated herein by reference.

### DESCRIPTION OF REFERENCE NUMERALS AND SIGNS

11 Metal casing
12 Catalyst carrier
13 Holding material
45 Substrate
50, 50A Protective film
60 Pore
X Width direction
Y Longitudinal direction

What is claimed is:

1. A holding material for a catalytic converter comprising a catalyst carrier, a metal casing for receiving the catalyst carrier, and the holding material wound around the catalyst carrier and interposed in a gap between the catalyst carrier and the metal casing,
wherein the holding material comprises an inorganic substrate and a protective film having a plurality of pores, and the protective film is joined to a metal casing-side surface of the substrate.

2. The holding material for a catalytic converter according to claim 1, wherein the protective film has a pore ratio of from 10% to 45%.

3. The holding material for a catalytic converter according to claim 1, wherein the pore has a circular shape or an ellipsoidal shape.

4. The holding material for a catalytic converter according to claim 1, wherein the pore has a length of the minimum diameter of 5 mm or more.

5. The holding material for a catalytic converter according to claim 1, wherein the protective film has a plurality of pores, and a distance between the adjacent pores is 3 mm or more.

6. The holding material for a catalytic converter according to claim 1, wherein the protective film having the pore formed thereon has a basis weight of 20 g/m² or less.

7. The holding material for a catalytic converter according to claim 1, which contains organic components in an amount of 3% by mass or less based on the total amount of the holding material.
